(19) United States
(12) Patent Application Publication
(10) Pub. No.: US 2006/0222953 A1
(43) Pub. Date: Oct. 5, 2006

(54) Nonaqueous electrolyte battery

(76) Inventors: Takao Inoue, Hyogo (JP); Kumiko Kanai, Osaka (JP); Kazunori Donoue, Hyogo (JP); Masahisa Fujimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/568,805

(22) PCT Filed: Aug. 11, 2004
(86) PCT No.: PCT/JP04/11794

§ 371 Date: Feb. 21, 2006

(30) Foreign Application Priority Data
Aug. 26, 2003 (JP) 2003-300867
Nov. 18, 2003 (JP) 2003-3877707

(51) Int. Cl. H01M 4/62

(52) U.S. Cl. 429/232

(57) ABSTRACT

A nonaqueous electrolyte battery wherein the per-volume capacity of positive electrode active material layer can be increased over that exhibited in the use of carbon as a conducting material. This nonaqueous electrolyte battery comprises positive electrode (1) containing a positive electrode active material layer, negative electrode (2) containing a negative electrode active material layer, nonaqueous electrolyte (5) and a conducting material contained in the positive electrode active material layer and constituted of at least one non-carbon material selected from the group consisting of nitrides, carbides and borides, which conducting material is in the form of particles of 0.2 to 5 μm average diameter easily dispersed in the positive electrode active material layer.

### TECHNICAL FIELD

The present invention relates to a nonaqueous electrolyte battery, and more particularly, it relates to a nonaqueous electrolyte battery whose positive electrode active material layer contains a conducting material.

### BACKGROUND TECHNIQUE

In general, a lithium secondary battery is known as a high-capacity nonaqueous electrolyte battery. Such a lithium secondary battery is disclosed in Japanese Patent Laying-Open No. 10-83818, for example. In this conventional lithium secondary battery, the capacity of the lithium secondary battery has been increased by increasing the filling density per volume of a positive electrode active material layer (mass per volume of the positive electrode active material layer (excluding the mass of a collector)). More specifically, the capacity per volume of the positive electrode active material layer has been increased by employing a layered rock salt material having a high true density as a positive electrode active material constituting the positive electrode active material layer. In general, further, carbon having a specific resistance of 4×10⁻⁵ Ωcm to 7×10⁻⁵ Ωcm has been employed as a conducting material contained in the positive electrode active material layer.

In the aforementioned lithium secondary battery as the conventional nonaqueous electrolyte battery, however, there has been such inconvenience that it is difficult to further increase the filling density of the positive electrode active material layer since the true density (2.2 g/ml) of carbon as the conducting material contained in the positive electrode active material layer is low. Consequently, there has been such a problem that it is difficult to further increase the capacity of the lithium secondary battery (nonaqueous electrolyte battery). Further, there has been such inconvenience that, in a case of setting the dissolution/deposition potential of lithium metal as the reference potential (0 V vs. Li/Li⁺), a nonaqueous electrolyte catalyzed by carbon is decomposed or anions (negative ions) of the electrolyte are doped into carbon when 4 V is exceeded with respect to the reference potential. In other words, there has been such a problem that carbon and the positive electrode active material as well as the nonaqueous electrolyte chemically react with each other under a high voltage (at least 4 V) thereby lowering the capacity of the lithium secondary battery (nonaqueous electrolyte battery).

### DISCLOSURE OF THE INVENTION

The present invention has been proposed in order to solve the aforementioned problem, and an object of the present invention is to provide a nonaqueous electrolyte battery capable of increasing the capacity per volume of a positive electrode active material layer as compared with a case of employing carbon as a conducting material.

In order to attain the aforementioned object, a nonaqueous electrolyte battery according to a first aspect of the present invention comprises a positive electrode including a positive electrode active material layer, a negative electrode including a negative electrode active material layer, a nonaqueous electrolyte and a conducting material, contained in the positive electrode active material layer and constituted of at least one non-carbon material selected from a group consisting of nitrides, carbides and borides, having particles of at least 0.2 μm and not more than 5 μm in average particle diameter easily dispersed into the positive electrode active material layer.

In this nonaqueous electrolyte battery according to the first aspect, the filling density of the positive electrode active material layer (mass per volume of the positive electrode active material layer) can be more increased than a case of employing carbon as the conducting material, by employing at least one non-carbon material selected from the group consisting of nitrides, carbides and borides as the conducting material contained in the positive electrode active material layer as hereinabove described. This is because at least one material selected from the group consisting of nitrides, carbides and borides has a higher true density than carbon. Thus, it is possible to increase the capacity per volume of the positive electrode active material layer. In this case, the average particle diameter of the particles of at least one material selected from the group consisting of nitrides, carbides and borides as the conducting material is so set to at least 0.2 μm and not more than 5 μm that dispersibility of the particles of at least one material selected from the group consisting of nitrides, carbides and borides improves, whereby it is possible to improve dispersibility of the conducting material contained in the positive electrode active material layer. Thus, excellent conductivity can be ensured. Further, at least one material selected from the group consisting of nitrides, carbides and borides as the conducting material is a material hardly causing chemical reaction with the nonaqueous electrolyte and a positive electrode active material constituting the positive electrode active material layer under a high voltage (at least 4 V) as compared with carbon, whereby reduction of the capacity resulting from chemical reaction of the conducting material can be suppressed. Thus, it is possible to increase the capacity of the nonaqueous electrolyte battery while suppressing reduction of the conductivity of the positive electrode active material layer and reduction of the capacity resulting from chemical reaction of the conducting material by employing at least one non-carbon material selected from the group consisting of nitrides, carbides and borides as the conducting material and setting the average particle diameter of the particles of the selected material to at least 0.2 μm and not more than 5 μm. When employing at least one material selected from a group consisting of nitrides, carbides and borides having conductivity approximate to the conductivity of carbon as the conducting material, more excellent conductivity can be ensured.

In the aforementioned nonaqueous electrolyte battery according to the first aspect, a positive electrode active material constituting the positive electrode active material layer preferably has a layered rock salt structure. According to this structure, the filling density of the positive electrode active material layer can be easily increased since the true density of the positive electrode active material having a layered rock salt structure is higher than that of a positive electrode active material having a spinel structure.

In this case, the positive electrode active material having a layered rock salt structure is preferably constituted of a material containing at least either cobalt or nickel. For example, the true density (5 g/ml) of layered rock salt lithium cobaltate and the true density (4.8 g/ml) of layered rock salt lithium nickelate are higher than the true density (4.3 g/ml) of spinel lithium manganate, whereby the filling density of the positive electrode active material layer can be easily increased when employing layered rock salt lithium cobaltate or layered rock salt lithium nickelate as the positive electrode active material constituting the positive electrode active material layer.

In the aforementioned nonaqueous electrolyte battery according to the first aspect, the conducting material may include a metal nitride. Since the true density (3 g/ml to 17 g/ml) of the metal nitride is higher than the true density (2.2 g/ml) of carbon, the filling density of the positive electrode active material layer can be easily increased when employing the metal nitride as the conducting material. In this case, excellent conductivity can be easily ensured when employing a metal nitride having a specific resistance approximate to the specific resistance (4×10⁻⁵ Ωcm to 7×10⁻⁵ Ωcm) of carbon as the conducting material.

In this case, the metal nitride preferably includes zirconium nitride (ZrN or Zr₃N₂). Since zirconium nitride has a true density of 7 g/ml and a specific resistance of 1.36×10⁻⁵ Ωcm, it is possible to easily increase the filling density of the positive electrode active material layer while ensuring excellent conductivity when employing zirconium nitride as the conducting material.

In this case, zirconium nitride constituting the conducting material is preferably contained in the positive electrode active material layer with a content of at least 1% and not more than 20%. According to this structure, reduction of the capacity per volume of the positive electrode active material layer resulting from reduction of the proportion of the positive electrode active material constituting the positive electrode active material layer can be suppressed.

In the aforementioned nonaqueous electrolyte battery according to the first aspect, the conducting material may include a metal carbide. Since the true density (3 g/ml to 17 g/ml) of the metal carbide is higher than the true density (2.2 g/ml) of carbon, the filling density of the positive electrode active material layer can be easily increased when employing the metal carbide as the conducting material. When employing a metal carbide having a specific resistance approximate to the specific resistance (4×10⁻⁵ Ωcm to 7×10⁻⁵ Ωcm) of carbon as the conducting material in this case, excellent conductivity can be easily ensured.

In the aforementioned nonaqueous electrolyte battery including the conducting material constituted of the metal carbide, the metal carbide may include tungsten carbide. Since tungsten carbide has a true density (15.77 g/ml) higher than the true density (2.2 g/ml) of carbon and a specific resistance (8×10⁻⁵ Ωcm) approximate to the specific resistance (4×10⁻⁵ Ωcm to 7×10⁻⁵ Ωcm) of carbon, it is possible to easily increase the filling density of the positive electrode active material layer while ensuring excellent conductivity when employing tungsten carbide as the conducting material.

In the aforementioned nonaqueous electrolyte battery including the conducting material constituted of the metal carbide, the metal carbide may include tantalum carbide. Since tantalum carbide has a true density (14.4 g/ml) higher than the true density (2.2 g/ml) of carbon and a specific resistance (3×10⁻⁵ Ωcm) approximate to the specific resistance (4×10⁻⁵ Ωcm to 7×10⁻⁵ Ωcm) of carbon, it is possible to easily increase the filling density of the positive electrode active material layer while ensuring excellent conductivity when employing tantalum carbide as the conducting material.

In the aforementioned nonaqueous electrolyte battery including the conducting material constituted of the metal carbide, the metal carbide may include zirconium carbide. Since zirconium carbide has a true density (6.66 g/ml) higher than the true density (2.2 g/ml) of carbon and a specific resistance (7×10⁻⁵ Ωcm) approximate to the specific resistance (4×10⁻⁵ Ωcm to 7×10⁻⁵ Ωcm) of carbon, it is possible to easily increase the filling density of the positive electrode active material layer while ensuring excellent conductivity when employing zirconium carbide as the conducting material.

The aforementioned nonaqueous electrolyte battery according to the first aspect preferably further comprises a binder, contained in the positive electrode active material layer, including polymer fluoride. Polymer fluoride, having relatively high flexibility among materials employed as binders, can improve flexibility of the positive electrode active material layer employing at least one material selected from the group consisting of nitrides, carbides and borides as the conducting material. Thus, the flexibility of the positive electrode including the positive electrode active material layer employing at least one material selected from the group consisting of nitrides, carbides and borides as the conducting material can be improved, whereby it is possible to inhibit the positive electrode from cracking when bending the positive electrode in a case of preparing a cylindrical or angular nonaqueous electrolyte battery. As the positive electrode of a lithium secondary battery, it is preferable that the filling density of the positive electrode active material layer is set to at least 4.0 g/ml, and that the positive electrode is not cracked when the positive electrode is bent to reach a radius of curvature of at least 12 times the thickness of the positive electrode active material layer.

In this case, the polymer fluoride preferably includes polyvinylidene fluoride. When introducing polyvinylidene fluoride into the positive electrode active material layer, the flexibility of this positive electrode active material layer can be easily improved.

In the aforementioned structure with the binder including polymer fluoride, the positive electrode is preferably cylindrically or angularly formed. According to this structure, it is possible to inhibit the positive electrode from cracking when bending the positive electrode in a case of preparing a cylindrical or angular nonaqueous electrolyte battery.

A nonaqueous electrolyte battery according to a second aspect of the present invention comprises a positive electrode including a positive electrode active material layer, a negative electrode including a negative electrode active material layer, a nonaqueous electrolyte and a conducting material contained in the positive electrode active material layer and constituted of a carbide.

In this nonaqueous electrolyte battery according to the second aspect, the filling density of the positive electrode active material layer (mass per volume of the positive electrode active material layer) can be more increased than a case of employing carbon as the conducting material, by employing the carbide as the conducting material contained in the positive electrode active material layer as hereinabove described. This is because the carbide has a higher true density than carbon. Thus, it is possible to increase the capacity per volume of the positive electrode active material layer. Further, the carbide as the conducting material is a material hardly causing chemical reaction with the nonaqueous electrolyte and a positive electrode active material constituting the positive electrode active material layer under a high voltage (at least 4 V) as compared with carbon, whereby reduction of the capacity resulting from chemical reaction of the conducting material can be suppressed. Thus, it is possible to increase the capacity of the nonaqueous electrolyte battery while suppressing reduction of the capacity resulting from chemical reaction of the conducting material by employing the carbide as the conducting material. When employing a carbide having conductivity approximate to the conductivity of carbon as the conducting material, excellent conductivity can be ensured.

The aforementioned nonaqueous electrolyte battery according to the second aspect preferably further comprises a binder, contained in the positive electrode active material layer, including polymer fluoride. Polymer fluoride, having relatively high flexibility among materials employed as binders, can improve flexibility of a positive electrode active material layer employing at least one material selected from a group consisting of nitrides, carbides and borides as the conducting material. Thus, the flexibility of the positive electrode including the positive electrode active material layer employing at least one material selected from the group consisting of nitrides, carbides and borides as the conducting material can be improved, whereby it is possible to inhibit the positive electrode from cracking when bending the positive electrode in a case of preparing a cylindrical or angular nonaqueous electrolyte battery. As the positive electrode of a lithium secondary battery, it is preferable that the filling density of the positive electrode active material layer is set to at least 4.0 g/ml, and that the positive electrode is not cracked when the positive electrode is bent to reach a radius of curvature of at least 12 times the thickness of the positive electrode active material layer.

In this case, the polymer fluoride preferably includes polyvinylidene fluoride. When introducing polyvinylidene fluoride into the positive electrode active material layer, the flexibility of this positive electrode active material layer can be easily improved.

In the aforementioned structure with the binder including polymer fluoride, the positive electrode is preferably cylindrically or angularly formed. According to this structure, it is possible to inhibit the positive electrode from cracking when bending the positive electrode in a case of preparing a cylindrical or angular nonaqueous electrolyte battery.

### BRIEF DESCRIPTION OF THE DRAWINGS

FIG. 1 is a graph showing particle size distribution of zirconium nitride as a conducting material employed in Example 1.

FIG. 2 is an SEM photograph of zirconium nitride as the conducting material employed in Example 1.

FIG. 3 is a graph showing particle size distribution of zirconium nitride as a conducting material employed in comparative example 1.

FIG. 4 is an SEM photograph of zirconium nitride as the conducting material employed in comparative example 1.

FIG. 5 is a perspective view showing a test cell prepared for checking the characteristics of positive electrodes of lithium secondary batteries (nonaqueous electrolyte batteries) according to Example 1, comparative example 1 and comparative example 2.

FIG. 6 is a graph showing results of a charge/discharge test performed as to a test cell corresponding to Example 1.

FIG. 7 is a graph showing results of a charge/discharge test performed as to a test cell corresponding to comparative example 1.

FIG. 8 is a graph showing results of a charge/discharge test performed as to a test cell corresponding to comparative example 2.

FIG. 9 is a graph showing the relation between average particle diameters of zirconium nitride and capacities.

FIG. 10 is a graph showing the relation between contents of conducting materials and capacities.

FIG. 11 is a graph showing particle size distribution of tungsten carbide as a conducting material employed in Example 2.

FIG. 12 is an SEM photograph of tungsten carbide as the conducting material employed in Example 2.

FIG. 13 is a graph showing particle size distribution of tantalum carbide as a conducting material employed in Example 4.

FIG. 14 is an SEM photograph of tantalum carbide as the conducting material employed in Example 4.

FIG. 15 is a graph showing particle size distribution of zirconium carbide as a conducting material employed in Example 5.

FIG. 16 is an SEM photograph of zirconium carbide as the conducting material employed in Example 5.

FIG. 17 is a graph showing results of a charge/discharge test performed as to a test cell corresponding to Example 2.

FIG. 18 is a graph showing results of a charge/discharge test performed as to a test cell corresponding to Example 3.

FIG. 19 is a graph showing results of a charge/discharge test performed as to a test cell corresponding to Example 4.

FIG. 20 is a graph showing results of a charge/discharge test performed as to a test cell corresponding to Example 5.

FIGS. 21 to 24 are photographs showing states at times of winding positive electrodes of lithium secondary batteries according to Example 6 on cylindrical members.

FIGS. 25 to 28 are photographs showing states at times of winding positive electrodes of lithium secondary batteries according to Example 7 on cylindrical members.

### BEST MODES FOR CARRYING OUT THE INVENTION

Examples of the present invention are now specifically described.

### EXAMPLE 1

[Preparation of Positive Electrode]

According to this Example 1, lithium cobaltate (LiCoO₂), zirconium nitride (ZrN or Zr₃N₂) and polyvinylidene fluoride (PVdF) were employed as a positive electrode active material, a conducting material and a binder constituting a positive electrode active material layer respectively. Lithium cobaltate as the positive electrode active material has a layered rock salt structure, and has a true density of 5 g/ml. Zirconium nitride as the conducting material has a true density of 7 g/ml and a specific resistance of 1.36×10⁻⁵ Ωcm.

According to Example 1, zirconium nitride having particles of at least 0.2 μm and not more than 5 μm in average particle diameter easily dispersed into the positive electrode active material layer was employed as the conducting material. Particle size distribution measurement was performed in order to check the specific average particle diameter of the particles of zirconium nitride as the conducting material employed in this Example 1. A laser diffraction particle size distribution measuring apparatus (SALD-2000, by Shimadzu Corporation) was employed for the particle size distribution measurement. The average particle diameter is a median diameter measured with the laser diffraction particle size distribution measuring apparatus.

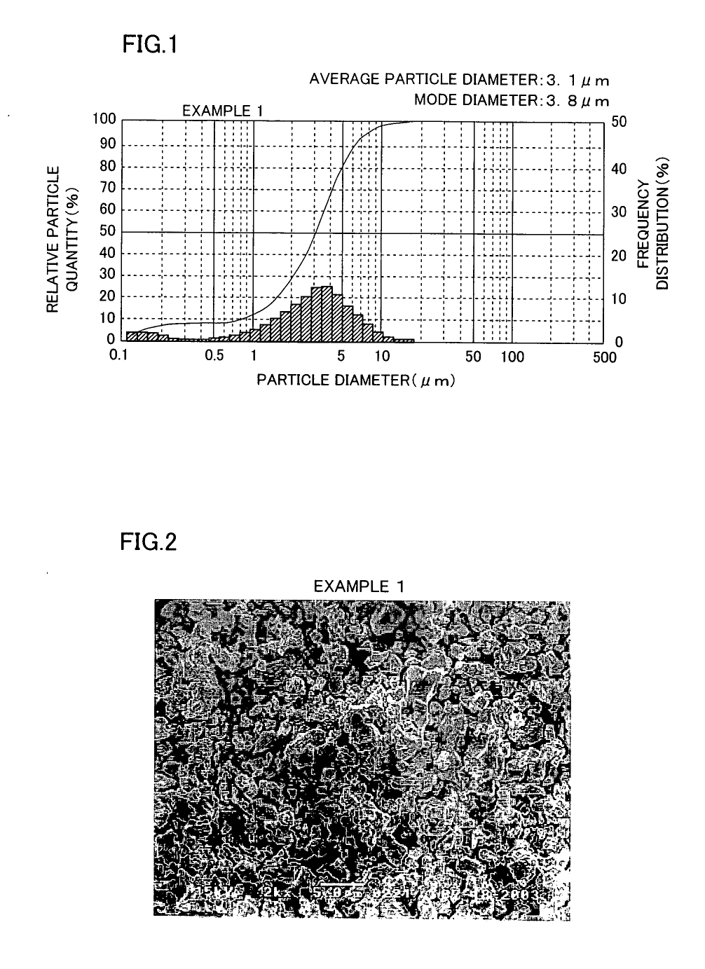

FIG. 1 is a graph showing the particle size distribution of zirconium nitride as the conducting material employed in Example 1, and FIG. 2 is an SEM (Scanning Electron Microscope: scanning electron microscope) of zirconium nitride as the conducting material employed in Example 1. The particle diameter (μm) is plotted on the abscissa of FIG. 1. Further, the relative particle quantity (%) is plotted on the left ordinate of FIG. 1, and shown by a curvilinear graph. Frequency distribution (%) is plotted on the right ordinate of FIG. 1, and shown by a bar graph. The relative particle quantity is the proportion of particles of not more than a prescribed particle diameter with respect to the overall particle quantity. The frequency distribution is the proportion of particles present in each particle diameter range with respect to the overall particle quantity when the range of the particle diameters is divided at regular intervals. The mode diameter in FIG. 2 is the particle diameter of particles maximumly present in the measured object.

Referring to FIG. 1, the average particle diameter (median diameter) of the particles of zirconium nitride as the conducting material employed in Example 1 is 3.1 μm, and it has been confirmable that the average particle diameter is at least 0.2 μm and not more than 5 μm. Further, the mode diameter is 3.8 μm, and it has been confirmable that the particles having particle diameters of at least 0.2 μm and not more than 5 μm are maximumly present.

Referring to FIG. 2, it has been proved that the particles of zirconium nitride as the conducting material employed in Example 1 homogeneously disperse over the whole. From this result, it is conceivable that dispersibility of the particles improves when the average particle diameter of zirconium nitride is 3.1 μm.

Then, lithium cobaltate (LiCoO₂) as the positive electrode active material, zirconium nitride (ZrN or Zr₃N₂) as the conducting material and polyvinylidene fluoride (PVdF) as the binder were so mixed with each other that the mass ratios LiCoO₂:ZrN or Zr₃N₂:PVdF were 87:10:3. Then, N-methyl-2-pyrrolidone was added to this mixture for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to Example 1. According to Example 1, the filling density of the positive electrode active material layer (mass per volume of the positive electrode active material layer) constituting the positive electrode was 4.49 g/ml. The filling density of the positive electrode active material layer in the present invention is that exclusive of the aluminum foil as the collector.

### COMPARATIVE EXAMPLE 1

[Preparation of Positive Electrode]

According to this comparative example 1, lithium cobaltate (LiCoO₂), zirconium nitride (ZrN or Zr₃N₂) and polyvinylidene fluoride (PVdF) were employed as a positive electrode active material, a conducting material and a binder constituting a positive electrode active material layer respectively, similarly to the aforementioned Example 1. In comparative example 1, however, zirconium nitride having particles larger than 5 μm in average particle diameter was employed as the conducting material. Particle size distribution measurement similar to that in the aforementioned Example 1 was performed in order to check the specific average particle diameter of the particles of zirconium nitride as the conducting material employed in this comparative example 1.

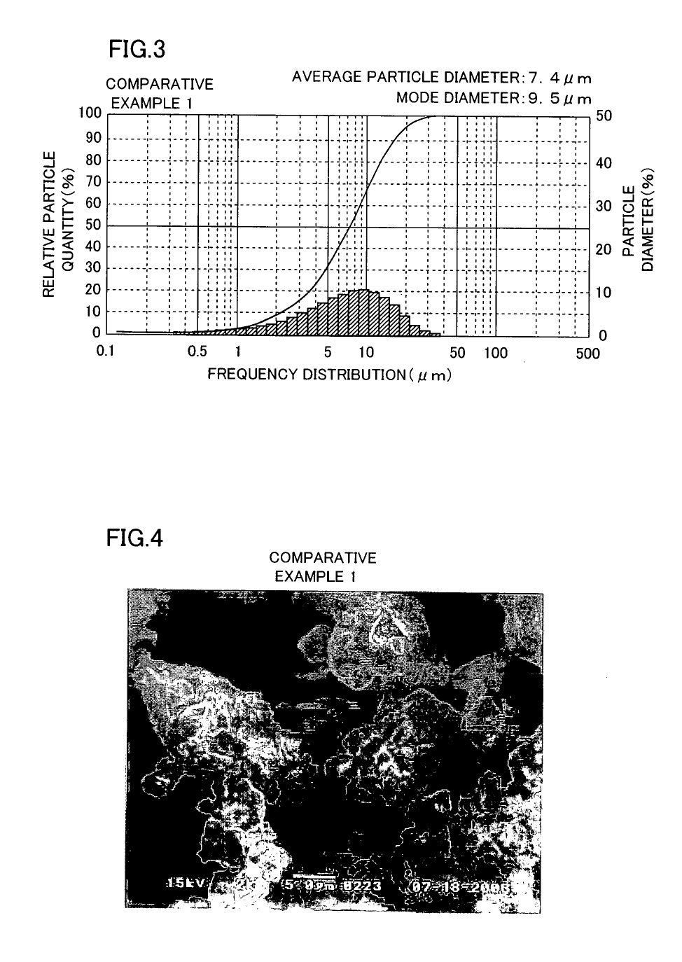

Referring to FIG. 3, the average particle diameter of the particles of zirconium nitride as the conducting material employed in comparative example 1 is 7.4 μm, and it has been confirmable that the average particle diameter is larger than 5 μm. Further, the mode diameter is 9.5 μm, and it has been confirmable that particles having particle diameters larger than 5 μm are maximumly present.

Referring to FIG. 4, it has been proved that the particles of zirconium nitride as the conducting material employed in comparative example 1 do not homogeneously disperse but dispersibility of the particles has lowered, dissimilarly to the aforementioned Example 1. From this result, it is conceivable that the dispersibility of the particles lowers when the average particle diameter of zirconium nitride is 7.4 μm. More specifically, fine particles flocculate into particles having particle diameters larger than 5 μm. Thus, it is conceivable that flocculation of fine particles more easily takes place in comparative example 1 whose average particle diameter is 7.4 μm as compared with Example 1 whose average particle diameter is 3.1 μm. Therefore, it is conceivable that the dispersibility of the particles more lowers in comparative example 1 than the aforementioned Example 1 since the dispersibility of the fine particles lowers.

Similarly to the aforementioned Example 1, N-methyl-2-pyrrolidone was added after mixing lithium cobaltate as the positive electrode active material, zirconium nitride as the conducting material and polyvinylidene fluoride as the binder with each other, for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to comparative example 1. According to comparative example 1, the filling density of the positive electrode active material layer constituting the positive electrode was 4.21 g/ml.

### COMPARATIVE EXAMPLE 2

[Preparation of Positive Electrode]

According to this comparative example 2, lithium cobaltate (LiCoO₂), carbon (C) and polyvinylidene fluoride (PVdF) were employed as a positive electrode active material, a conducting material and a binder constituting a positive electrode active material layer respectively. Carbon as the conducting material has a true density of 2.2 g/ml and a specific resistance of 4×10⁻⁵ Ωcm to 7×10⁻⁵ Ωcm.

Lithium cobaltate (LiCoO₂) as the positive electrode active material, carbon (C) as the conducting material and polyvinylidene fluoride (PVdF) as the binder were mixed with each other so that the mass ratios LiCoO₂:C:PVdF were 90:5:5. Then, N-methyl-2-pyrrolidone was added to this mixture for preparing a positive electrode mixture slurry as a positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to comparative example 2. According to comparative example 2, the filling density of the positive electrode active material layer constituting the positive electrode was 3.70 g/ml.

### COMMON TO EXAMPLE 1, COMPARATIVE EXAMPLE 1 AND COMPARATIVE EXAMPLE 2

[Preparation of Nonaqueous Electrolyte]

A nonaqueous electrolyte of the lithium secondary battery (nonaqueous electrolyte battery) was prepared by dissolving 1 mol/liter of lithium hexafluorophosphate (LiPF₆) as an electrolyte (solute) in a mixed solvent obtained by mixing ethylene carbonate (EC) and diethyl carbonate (DEC) at a volume ratio of 50:50.

[Preparation of Test Cell]

Referring to FIG. 5, a positive electrode 1 and a negative electrode 2 were arranged in a vessel 10 so that the positive electrode 1 and the negative electrode 2 were opposed to each other through a separator 3, while a reference electrode 4 was also arranged in the vessel 10 as a preparation process for a test cell. The test cell was prepared by injecting a nonaqueous electrolyte 5 into the vessel 10. A positive electrode prepared in the aforementioned manner was employed as the positive electrode 1, while lithium (Li) metal was employed as the negative electrode 2 and the reference electrode 3. A nonaqueous electrolyte prepared in the aforementioned manner was employed as the nonaqueous electrolyte 5.

[Charge/Discharge Test]

Charge/discharge tests were performed as to respective test cells corresponding to Example 1, comparative example 1 and comparative example 2 prepared in the aforementioned manner. As to conditions of this charging/discharging, charging was performed up to 4.3 V with constant current of 1.5 mA, and discharging was thereafter performed up to 2.75 V with the constant current of 1.5 mA. Then, post-discharge capacities were measured.

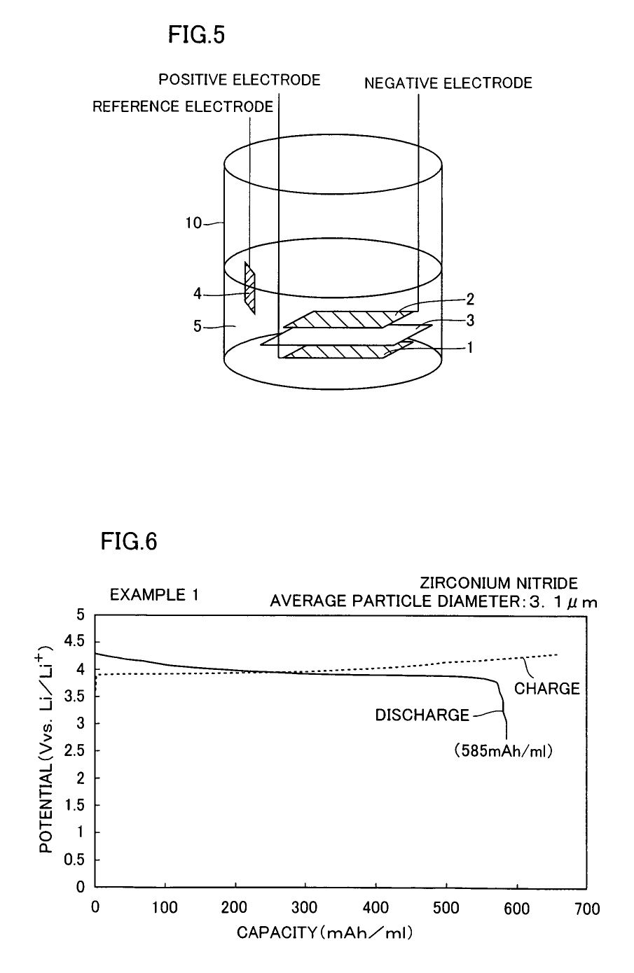

FIGS. 6 to 8 are graphs showing results of the charge/discharge tests performed as to the respective test cells corresponding to Example 1, comparative example 1 and comparative example 2 respectively. The capacities (mAh/ml) shown in FIGS. 6 to 8 are capacities per volume of the positive electrode active material layers.

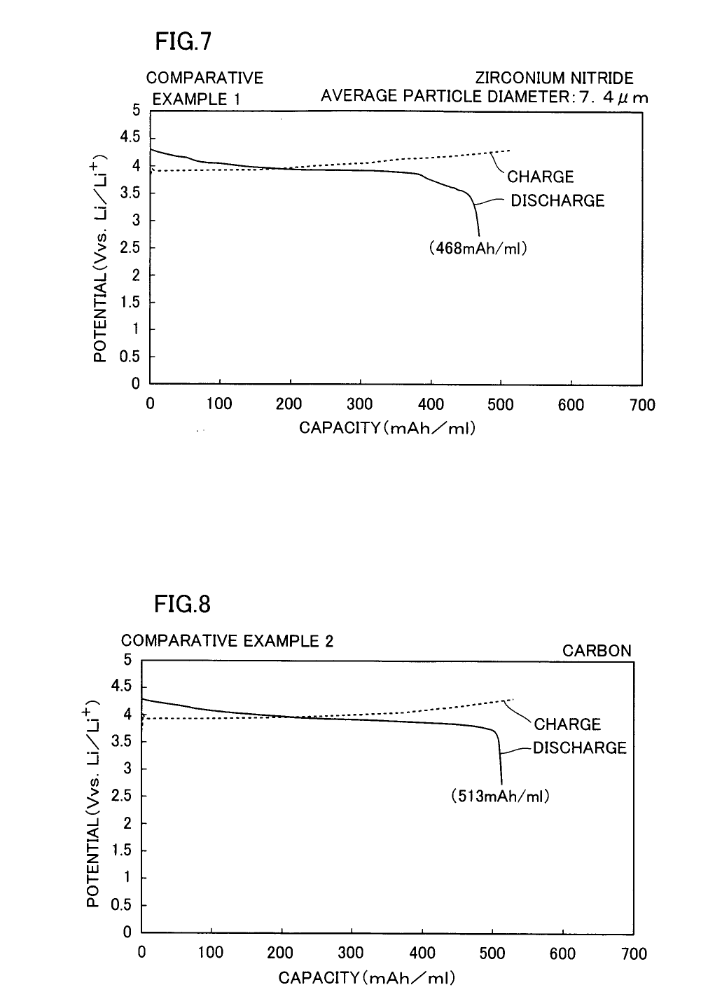

Referring to FIGS. 6 and 7, it has been proved that the post-discharge capacity is higher in Example 1 employing zirconium nitride having the particles of 3.1 μm in average particle diameter as the conducting material than comparative example 1 employing zirconium nitride having the particles of 7.4 μm in average particle diameter as the conducting material. More specifically, the capacity was 468 mAh/ml in comparative example 1, while the capacity was 585 mAh/ml in Example 1.

From this result, it is conceivable that the dispersibility of the conducting material contained in the positive electrode active material layer also improves since zirconium nitride having the particles of 3.1 μm in average particle diameter is so employed as the conducting material that the dispersibility of the particles of zirconium nitride improves in Example 1. Thus, it was conceivably possible to ensure excellent conductivity in Example 1. On the other hand, the dispersibility of the particles of zirconium nitride lowers in comparative example 1 employing zirconium nitride having the particles of 7.4 μm in average particle diameter, whereby it is conceivable that the dispersibility of the conducting material contained in the positive electrode active material layer also lowers. Thus, the particle quantity of the conducting material per volume of the positive electrode active material decreases, and hence it has been conceivably rendered difficult to ensure sufficient conductivity.

Referring to FIGS. 6 and 8, it has been proved that the post-discharge capacity is higher in Example 1 employing zirconium nitride as the conducting material than comparative example 2 employing carbon as the conducting material. More specifically, the capacity was 513 mAh/ml in comparative example 2, while the capacity was 585 mAh/ml in Example 1.

From this result, it is conceivable that the capacity per volume of the positive electrode active material layer was increased since zirconium nitride (7 g/ml) having the higher true density than carbon (2.2 g/ml) is so employed as the conducting material that the filling density of the positive electrode active material layer is increased. Further, it is conceivable that reduction of the capacity resulting from chemical reaction of the conducting material was suppressed since zirconium nitride as the conducting material is a material hardly causing chemical reaction with the nonaqueous electrolyte (mixed solvent of EC and DEC in which LiPF₆ is dissolved) and the positive electrode active material (LiCoO₂) under a high voltage (at least 4 V) as compared with carbon.

According to Example 1, as hereinabove described, zirconium nitride having the true density of 7 g/ml is so employed as the conducting material that the filling density of the positive electrode active material layer (mass per volume of the positive electrode active material layer) can be more increased than the case of employing carbon having the true density of 2.2 g/ml as the conducting material, whereby it is possible to increase the capacity per volume of the positive electrode active material layer. In this case, the dispersibility of the conducting material contained in the positive electrode active material layer can be improved by setting the average particle diameter of the particles of zirconium nitride as the conducting material to 3.1 μm according to Example 1, whereby excellent conductivity can be ensured. Further, the specific resistance (1.36×10⁻⁵ Ωcm) of zirconium nitride is approximate to the specific resistance (4×10⁻⁵ Ωcm to 7×10⁻⁵ Ωcm) of carbon, whereby the conductivity does lot lower due to the employment of zirconium nitride as the conducting material. In addition, zirconium nitride as the conducting material is a material hardly causing chemical reaction under a high voltage (4 V) as compared with carbon, whereby reduction of the capacity resulting from chemical reaction of the conducting material can be suppressed. Thus, it is possible to increase the capacity of the lithium secondary battery (nonaqueous electrolyte battery) while suppressing reduction of the conductivity of the positive electrode active material layer and reduction of the capacity resulting from chemical reaction of the conducting material by employing zirconium nitride as the conducting material and setting the average particle diameter of the particles of this zirconium nitride to 3.1 μm.

According to Example 1, further, the filling density of the positive electrode active material layer can be easily increased by employing layered rock salt type lithium cobaltate as the positive electrode active material since the true density (5 g/ml) of layered rock salt lithium cobaltate is higher than the true density (4.3 g/ml) of spinel lithium manganate, for example.

Then, changes of capacities depending on differences between average particle diameters (7.4 μm, 6.6 μm, 5.0 μm, 3.1 μm and 2.3 μm) of zirconium nitride were checked in the case of employing zirconium nitride as the conducting material.

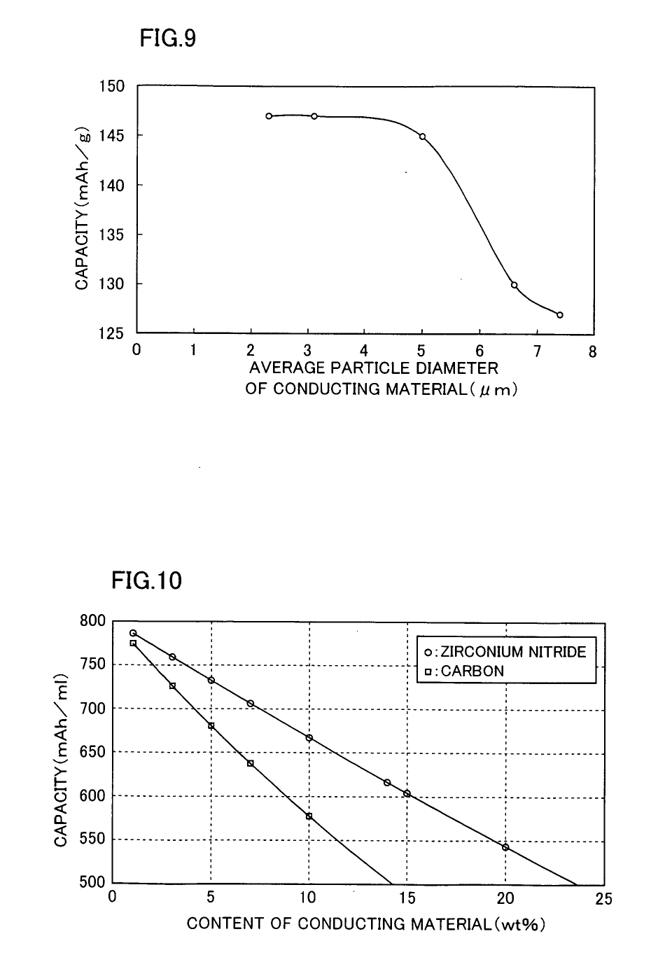

FIG. 9 is a graph showing the relation between the average particle diameters of zirconium nitride and the capacities. The capacities shown in FIG. 9 are capacities per mass of the positive electrode active material (mass of only the positive electrode active material excluding the conducting material and the binder). Referring to FIG. 9, it has been proved that the capacity abruptly lowers when the average particle diameter exceeds 5 μm. On the other hand, it has been proved that a high capacity (at least 145 mAh/g) can be obtained when the average particle diameter is not more than 5 μm.

From this result, it was conceivably possible to ensure excellent conductivity since the conducting material contained in the positive electrode active material layer is homogeneously dispersed to improve the dispersibility when the average particle diameter of zirconium nitride as the conducting material is not more than 5 μm. On the other hand, it was conceivably rendered difficult to ensure excellent conductivity since dispersion of the conducting material is conceivably inhomogenized to reduce the dispersibility when the average particle diameter of zirconium nitride as the conducting material exceeds 5 μm. Further, it is conceivably rendered difficult to ensure sufficient conductivity when the average particle diameter of zirconium nitride as the conducting material is too small since the contact area between conducting materials contained in the positive electrode active material layer decreases, although this is not illustrated. Thus, it is conceivable that the average particle diameter of zirconium nitride as the conducting material is preferably at least 0.2 μm and not more than 5 μm.

Then, changes of capacities depending on differences between contents of conducting materials (zirconium nitride and carbon) contained in positive electrode active material layers were checked.

FIG. 10 is a graph showing the relation between the contents of the conducting materials and the capacities. The capacities shown in FIG. 10 are capacities per volume of the positive electrode active material layers (volumes of only the positive electrode active material layers). Referring to FIG. 10, it has been proved that the capacity decreases when the content of the conducting material exceeds 20%, in the case of employing zirconium nitride as the conducting material. On the other hand, it has been proved that the capacity exceeds 500 mAh/ml when the content of the conducting material is not more than 20%. In particular, it has been proved that an extremely high capacity (at least 700 mAh/ml) can be obtained when the content of the conducting material is at least 1% and not more than 7%. Further, it has been proved that a capacity of at least 650 mAh/ml can be obtained when the content of the conducting material is at least 1% and not more than 10%, and that a capacity of at least 600 mAh/ml can be obtained when the content of the conducting material is at least 1% and not more than 15%.

From this result, it is conceivable that the capacity lowers when the content of zirconium nitride as the conducting material exceeds 20%, since the proportion of the positive electrode active material with respect to the positive electrode active material layer decreases. Thus, it is conceivable that the content of zirconium nitride as the conducting material is preferably at least 1% and not more than 20%. When the content of zirconium nitride as the conducting material is either at least 1% and not more than 10% or at least 1% and not more than 15%, it is conceivably more preferable since a relatively high capacity can be obtained. When the content of zirconium nitride as the conducting material is at least 1% and not more than 7%, further, it is conceivably most preferable since an extremely high capacity can be obtained.

In addition, zirconium nitride and carbon were so compared with each other that it has been confirmable that a higher capacity can be obtained by employing zirconium nitride (7 g/ml) having the higher true density than carbon (2.2 g/ml) if the contents thereof are identical to each other.

### EXAMPLE 2

[Preparation of Positive Electrode]

According to this Example 2, lithium cobaltate (LiCoO₂), tungsten carbide (WC) and polyvinylidene fluoride (PVdF) were employed as a positive electrode active material, a conducting material and a binder constituting a positive electrode active material layer respectively. Tungsten carbide as the conducting material has a true density of 15.77 g/ml and a specific resistance of 8×10⁻⁵ Ωcm.

According to Example 2, tungsten carbide having particles of at least 0.2 μm and not more than 5 μm in average particle diameter easily dispersed into the positive electrode active material layer was employed as the conducting material. In order to check the specific average particle diameter of the particles of tungsten carbide as the conducting material employed in this Example 2, particle size distribution measurement similar to that in the aforementioned Example 1 was performed.

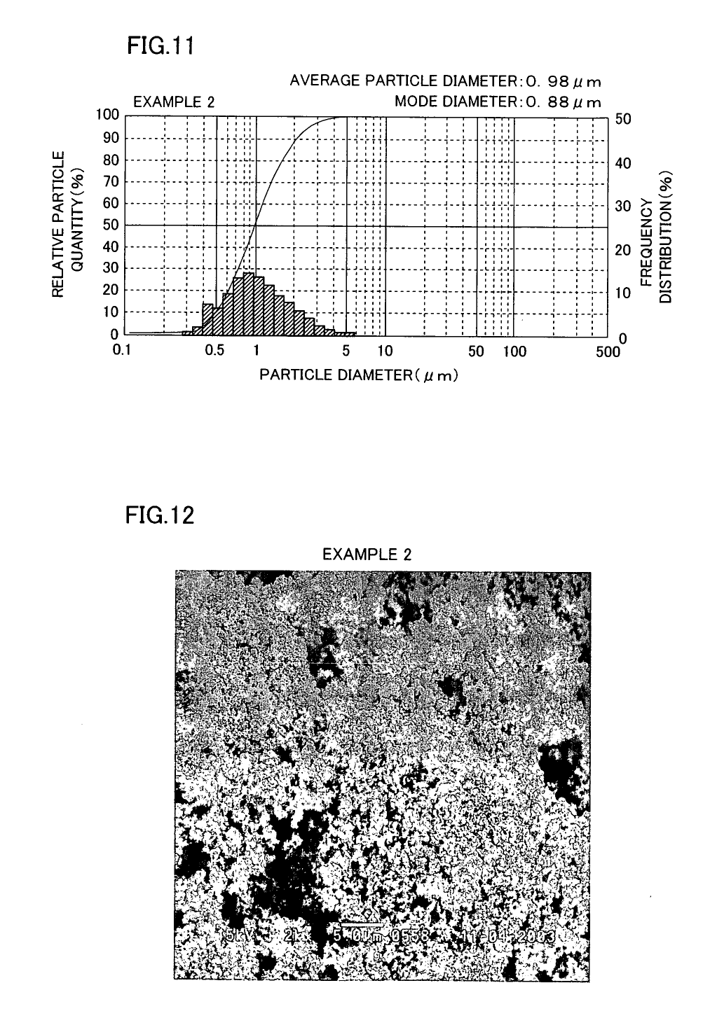

Referring to FIG. 11, the average particle diameter of the particles of tungsten carbide as the conducting material employed in Example 2 is 0.98 μm, and it has been confirmable that the average particle diameter is at least 0.2 μm and not more than 5 μm. Further, the mode diameter is 0.88 μm, and it has been confirmable that the particles having particle diameters of at least 0.2 μm and not more than 5 μm are maximumly present.

Referring to FIG. 12, it has been proved that the particles of tungsten carbide as the conducting material employed in Example 2 homogeneously disperse over the whole. From this result, it is conceivable that the dispersibility of the particles improves when the average particle diameter of tungsten carbide is 0.98 μm.

Then, lithium cobaltate (LiCoO₂) as the positive electrode active material, tungsten carbide (WC) as the conducting material and polyvinylidene fluoride (PVdF) as the binder were so mixed with each other that the mass ratios LiCoO₂:WC:PVdF were 85:10:5. Then, N-methyl-2-pyrrolidone was added to this mixture for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to Example 2. According to Example 2, the filling density of the positive electrode active material layer constituting the positive electrode was 4.29 g/ml.

### EXAMPLE 3

[Preparation of Positive Electrode]

According to this Example 3, lithium cobaltate (LiCoO₂), tungsten carbide (WC) and polyvinylidene fluoride (PVdF) were employed as a positive electrode active material, a conducting material and a binder constituting a positive electrode active material layer respectively, similarly to the aforementioned Example 2. According to Example 3, tungsten carbide having particles of at least 0.2 μm and not more than 5 μm (0.98 μm) in average particle diameter easily dispersed into the positive electrode active material layer was employed as the conducting material, similarly to the aforementioned Example 2.

Lithium cobaltate (LiCoO₂) as the positive electrode active material, tungsten carbide (WC) as the conducting material and polyvinylidene fluoride (PVdF) as the binder were so mixed with each other that the mass ratios LiCoO₂:WC:PVdF were 90:5:5. In other words, the materials were so mixed with each other that the content of tungsten carbide as the conducting material was lower than that in the aforementioned Example 2 (10%). Then, N-methyl-2-pyrrolidone was added to this mixture for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to Example 3. According to Example 3, the filling density of the positive electrode active material layer constituting the positive electrode was 4.44 g/ml.

### EXAMPLE 4

[Preparation of Positive Electrode]

According to this Example 4, lithium cobaltate (LiCoO₂), tantalum carbide (TaC) and polyvinylidene fluoride (PVdF) were employed as a positive electrode active material, a conducting material and a binder constituting a positive electrode active material layer respectively. Tantalum carbide as the conducting material has a true density of 14.4 g/ml and a specific resistance of 3×10⁻⁵ Ωcm.

According to Example 4, tantalum carbide having particles of at least 0.2 μm and not more than 5 μm in average particle diameter easily dispersed into the positive electrode active material layer was employed as the conducting material. In order to check the specific average particle diameter of the particles of tantalum carbide as the conducting material employed in this Example 4, particle size distribution measurement similar to that in the aforementioned Example 1 was performed.

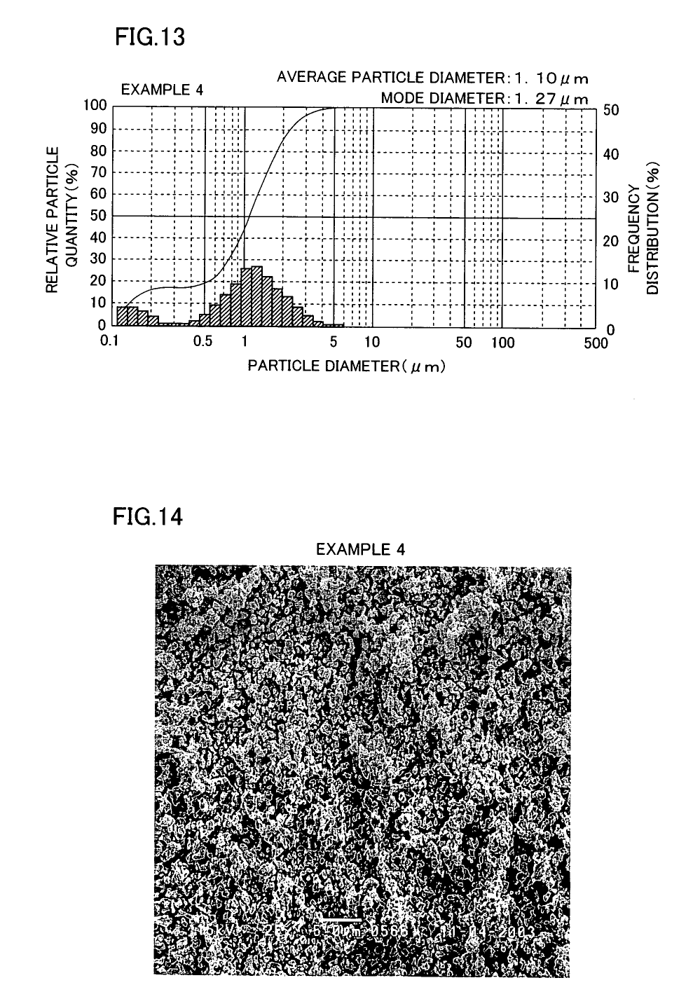

Referring to FIG. 13, the average particle diameter of the particles of tantalum carbide as the conducting material employed in Example 4 is 1.10 μm, and it has been confirmable that the average particle diameter is at least 0.2 μm and not more than 5 μm. Further, the mode diameter is 1.27 μm, and it has been confirmable that the particles having particle diameters of at least 0.2 μm and not more than 5 μm are maximumly present.

Referring to FIG. 14, it has been proved that the particles of tantalum carbide as the conducting material employed in Example 4 homogeneously disperse over the whole. From this result, it is conceivable that the dispersibility of the particles improves when the average particle diameter of tantalum carbide is 1.10 μm.

Then, lithium cobaltate (LiCoO₂) as the positive electrode active material, tantalum carbide (TaC) as the conducting material and polyvinylidene fluoride (PVdF) as the binder were so mixed with each other that the mass ratios LiCoO₂:TaC:PVdF were 85:10:5. Then, N-methyl-2-pyrrolidone was added to this mixture for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to Example 4. According to Example 4, the filling density of the positive electrode active material layer constituting the positive electrode was 4.60 g/ml.

### EXAMPLE 5

[Preparation of Positive Electrode]

According to this Example 5, lithium cobaltate (LiCoO₂), zirconium carbide (ZrC) and polyvinylidene fluoride (PVdF) were employed as a positive electrode active material, a conducting material and a binder constituting a positive electrode active material layer respectively. Zirconium carbide as the conducting material has a true density of 6.66 g/ml and a specific resistance of 7×10⁻⁵ Ωcm.

According to Example 5, zirconium carbide having particles of at least 0.2 μm and not more than 5 μm in average particle diameter easily dispersed into the positive electrode active material layer was employed as the conducting material. In order to check the specific average particle diameter of the particles of zirconium carbide as the conducting material employed in this Example 5, particle size distribution measurement similar to that in the aforementioned Example 1 was performed.

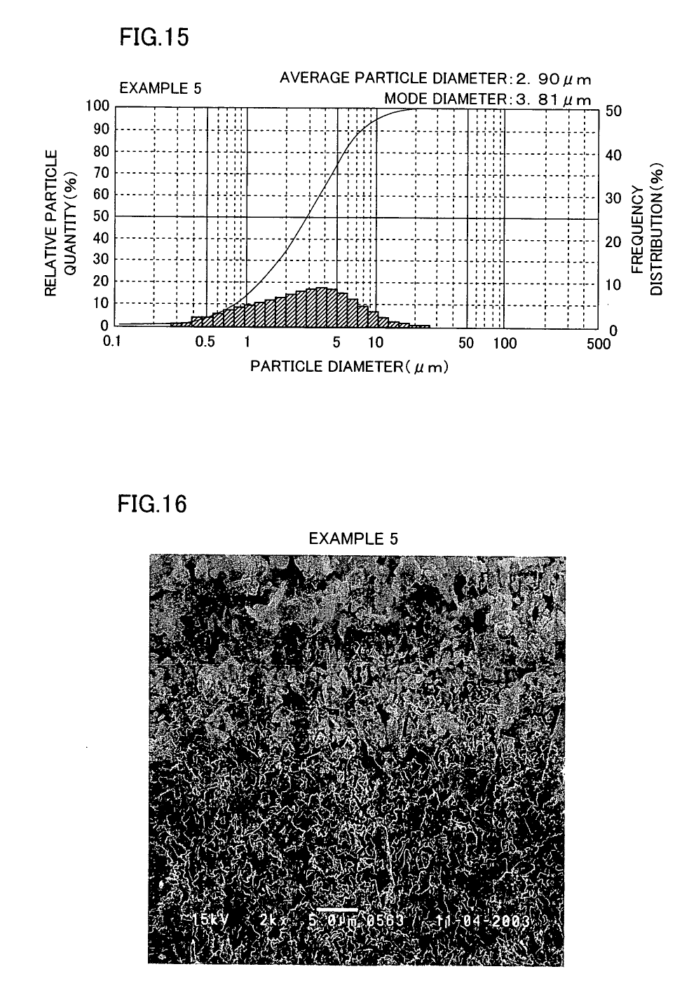

Referring to FIG. 15, the average particle diameter of the particles of zirconium carbide as the conducting material employed in Example 5 is 2.90 μl, and it has been confirmable that the average particle diameter is at least 0.2 μm and not more than 5 μm. Further, the mode diameter is 3.81 μm, and it has been confirmable that the particles having particle diameters of at least 0.2 μm and not more than 5 μm are maximumly present.

Referring to FIG. 16, it has been proved that the particles of zirconium carbide as the conducting material employed in Example 5 homogeneously disperse over the whole. From this result, it is conceivable that the dispersibility of the particles improves when the average particle diameter of zirconium carbide is 2.90 μm.

Then, lithium cobaltate (LiCoO₂) as the positive electrode active material, zirconium carbide (ZrC) as the conducting material and polyvinylidene fluoride (PVdF) as the binder were so mixed with each other that the mass ratios LiCoO₂:ZrC:PVdF were 85:10:5. Then, N-methyl-2-pyrrolidone was added to this mixture for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to Example 5. According to Example 5, the filling density of the positive electrode active material layer constituting the positive electrode was 4.43 g/ml.

### COMMON TO EXAMPLE 2 TO EXAMPLE 5

[Preparation of Test Cell]

In order to check the characteristics of the positive electrodes of the lithium secondary batteries (nonaqueous electrolyte batteries) according to Examples 2 to 5, test cells similar to the test cell shown in FIG. 5 were prepared. However, the positive electrodes of the lithium secondary batteries (nonaqueous electrolyte batteries) according to Examples 2 to 5 prepared in the aforementioned manner were employed as positive electrodes 1.

[Charge/Discharge Test]

As to the respective cells corresponding to Examples 2 to 5 prepared in the aforementioned manner, charge/discharge tests were performed under conditions similar to those for the aforementioned Example 1, comparative example 1 and comparative example 2. In other words, charging was performed up to 4.3 V with constant current of 1.5 mA, and discharging was thereafter performed up to 2.75 V with the constant current of 1.5 mA. Then, post-discharge capacities were measured.

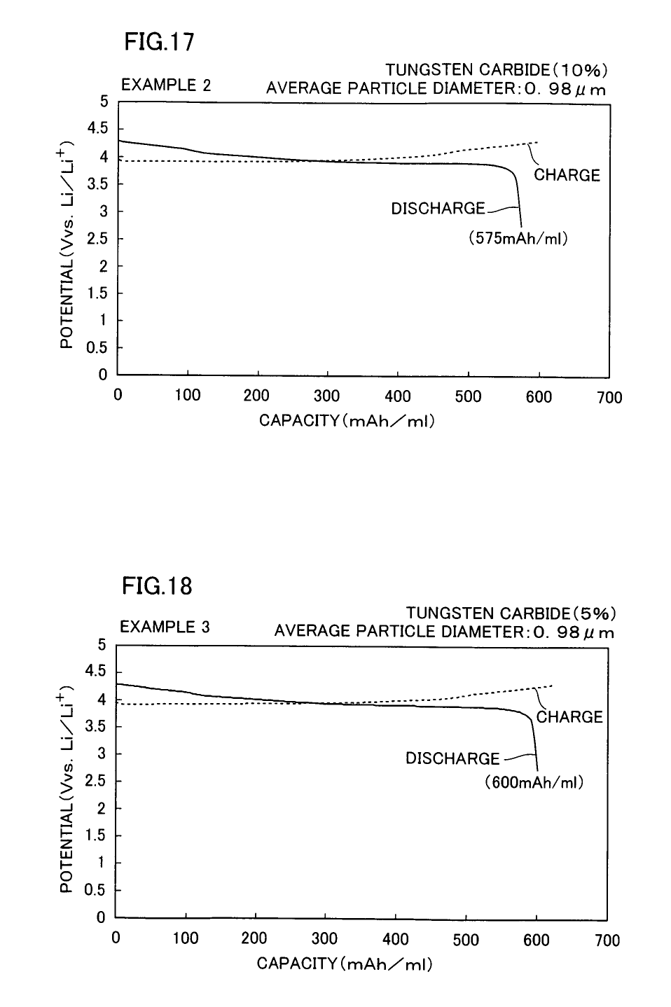

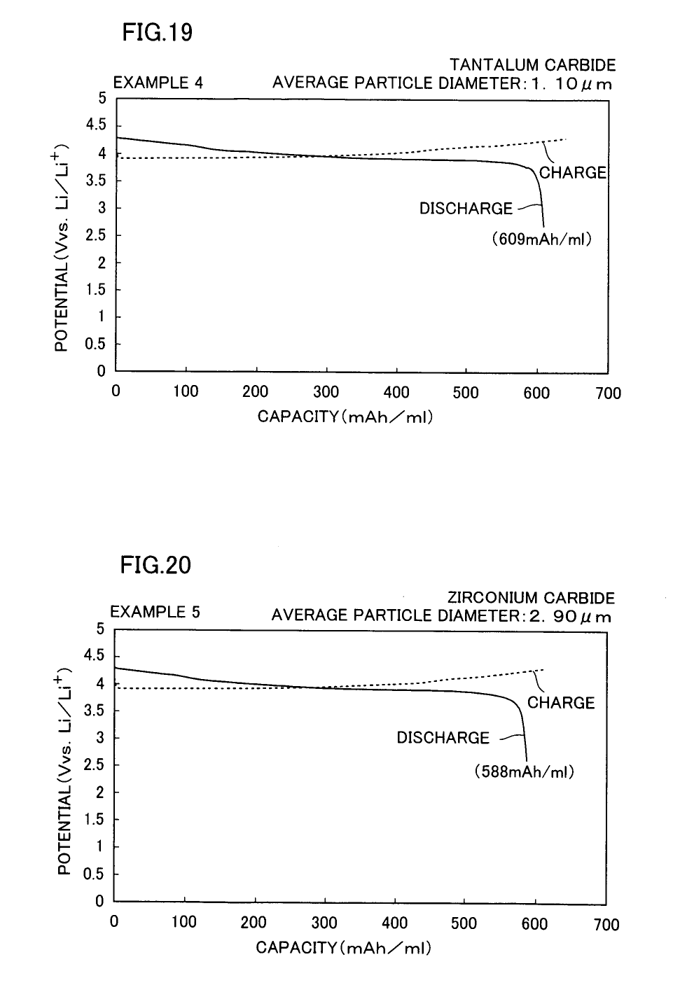

FIGS. 17 to 20 are graphs showing results of the charge/discharge tests performed as to the respective test cells corresponding to Examples 2 to 5 respectively. The capacities (mAh/ml) shown in FIGS. 17 to 20 are capacities per volume of the positive electrode active material layers.

Referring to FIG. 8 and FIGS. 17 to 20, it has been proved that the post-discharge capacities are higher in Examples 2 to 5 employing carbides (tungsten carbide, tantalum carbide and zirconium nitride) as the conducting materials than comparative example 2 employing carbon as the conducting material. More specifically, the post-discharge capacities of Examples 2 and 3 employing tungsten carbide as the conducting materials were 575 mAh/ml and 600 mAh/ml respectively. Further, the post-discharge capacity of Example 4 employing tantalum carbide as the conducting material was 609 mAh/ml. In addition, the post-discharge capacity of Example 5 employing zirconium carbide as the conducting material was 588 mAh/ml. On the other hand, the post-discharge capacity of comparative example 2 employing carbon as the conducting material was 513 mAh/ml.

From this result, it is conceivable that the capacities per volume of the positive electrode active material layers were increased since the filling densities of the positive electrode active material layers are increased by employing the carbides (tungsten carbide: 15.77 g/ml, tantalum carbide: 14.4 g/ml and zirconium carbide: 6.66 g/ml) whose true densities are higher than that of carbon (2.2 g/ml). Further, it is conceivable that reduction of the capacities resulting from chemical reaction of the conducting materials was suppressed since the carbides (tungsten carbide, tantalum carbide and zirconium carbide) as the conducting materials are materials hardly causing chemical reaction with the nonaqueous electrolytes (mixed solvents of EC and DEC in which LiPF₆ is dissolved) under a high voltage (at least 4 V) as compared with carbon.

Further, it is conceivable that the dispersibility of the conducting materials contained in the positive electrode active material layers also improves since the dispersibility of the particles of the carbides improves due to the employment of the carbides (tungsten carbide: 0.98 μm, tantalum carbide: 1.10 μm and zirconium nitride: 2.90 μm) having the particles of at least 0.2 μm and not more than 5 μm as the conducting materials. Thus, it was conceivably possible to ensure excellent conductivity in Examples 2 to 5.

According to Examples 2 to 5, as hereinabove described, it is possible to increase the capacities of the lithium secondary batteries (nonaqueous electrolyte batteries) while suppressing reduction of conductivity of the positive electrode active material layers and reduction of the capacities resulting from chemical reaction of the conducting materials similarly to Example 1 employing the nitride (zirconium nitride: 3.1 μm) having the particles of at least 0.2 μm and not more than 5 μm in average particle diameter, by employing the carbides (tungsten carbide, tantalum carbide and zirconium carbide) as the conducting materials and setting the average particle diameters of the particles of these carbides to at least 0.2 μm and not more than 5 μm (tungsten carbide: 0.98 μm, tantalum carbide: 1.10 μm and zirconium carbide: 2.90 μm). Further, the specific resistances of tungsten carbide, tantalum carbide and zirconium carbide as the conducting materials are 8×10⁻⁵ Ωcm, 3×10⁻⁵ Ωcm and 7×10⁻⁵ Ωcm respectively and approximate to the specific resistance (4×10⁻⁵ Ωcm to 7×10⁻⁵ Ωcm) of carbon, whereby the conductivity does not lower as compared with the case of employing carbon as the conducting material.

According to Examples 2 to 5, further, lithium cobaltate is so employed as the positive electrode active materials that the filling densities of the positive electrode active material layers can be easily increased similarly to the aforementioned Example 1 since lithium cobaltate has the relatively high true density (5 g/ml).

Then, Example 2 (see FIG. 17) in which the content of tungsten carbide as the conducting material is 10%, Example 3 (see FIG. 18) in which the content of tungsten carbide is 5% and comparative example 2 (see FIG. 8) employing carbon as the conducting material were so compared with each other that it has been proved that both of the post-discharge capacities (575 mAh/ml and 600 mAh/ml) of Examples 2 and 3 exceed the post-discharge capacity (513 mAh/ml) of comparative example 2. From this result, it is conceivably preferable to set the content of tungsten carbide to the range of at least 5% to 10% when employing tungsten carbide as the conducting material.

Flexibility experiments performed for checking flexibility of positive electrodes at times of preparing cylindrical lithium secondary batteries are now described with reference to Example 6 and Example 7.

### EXAMPLE 6

[Preparation of Positive Electrode]

According to this Example 6, lithium cobaltate (LiCoO₂), tungsten carbide (WC) and polyvinylidene fluoride (PVdF) were employed as a positive electrode active material, a conducting material and a binder constituting a positive electrode active material layer respectively, similarly to the aforementioned Examples 2 and 3. According to Example 6, tungsten carbide having particles of at least 0.2 μm and not more than 5 μm in average particle diameter easily dispersed into the positive electrode active material layer was employed as the conducting material, similarly to the aforementioned Examples 2 and 3.

Lithium cobaltate (LiCoO₂) as the positive electrode active material, tungsten carbide (WC) as the conducting material and polyvinylidene fluoride (PVdF) as the binder were so mixed with each other that the mass ratios LiCoO₂:WC:PVdF were 92:5:3. Thereafter N-methyl-2-pyrrolidone was added to this mixture for preparing a positive electrode mixture slurry as the positive electrode active material layer.

Then, the positive electrode mixture slurry as the positive electrode active material layer was applied to both of the front and back surfaces of aluminum foil as a collector having a thickness of 20 μm. At this time, the positive electrode mixture slurry was so applied that the amount of coating was 50 mg/cm² on both surfaces (front and back surfaces) of the aluminum foil. The total thickness of the positive electrode mixture slurry (positive electrode active material layer) excluding the aluminum foil in this case was 125 μm. According to Example 6, the filling density of the positive electrode active material layer was 4.0 g/ml. Thus, the positive electrode of a lithium secondary battery according to Example 6 was prepared.

### EXAMPLE 7

According to this Example 7, polyacrylonitrile (PAN) was employed as a binder constituting a positive electrode active material layer, dissimilarly to the aforementioned Example 6. As a positive electrode active material and a conducting material constituting the positive electrode active material layer, lithium cobaltate (LiCoO₂) and tungsten carbide (WC) were employed respectively, similarly to the aforementioned Example 6. According to Example 7, tungsten carbide having particles of at least 0.2 μm and not more than 5 μm (0.98 μm) in average particle diameter easily dispersed into the positive electrode active material layer was employed as the conducting material, similarly to the aforementioned Example 6.

Then, lithium cobaltate (LiCoO₂) as the positive electrode active material, tungsten carbide (WC) as the conducting material and polyacrylonitrile (PAN) as the binder were so mixed with each other that the mass ratios LiCoO₂:WC:PAN were 92:5:3. Thereafter N-methyl-2-pyrrolidone was added to this mixture for preparing a positive electrode mixture slurry as the positive electrode active material layer.

Then, the positive electrode mixture slurry as the positive electrode active material layer was applied to both of the front and back surfaces of aluminum foil as a collector having a thickness of 20 μm so that the amount of coating was 50 mg/cm² on both surfaces of the aluminum foil, similarly to the aforementioned Example 6. The total thickness of the positive electrode mixture slurry excluding the aluminum foil in this case was 125 μm, which was identical to the thickness of the positive electrode mixture slurry according to the aforementioned Example 6. According to Example 7, the filling density of the positive electrode active material layer was 4.0 g/ml, which was identical to the filling density of the positive electrode active material layer of the aforementioned Example 6. Thus, the positive electrode of a lithium secondary battery according to Example 7 was prepared.

[Flexibility Experiment on Positive Electrode]

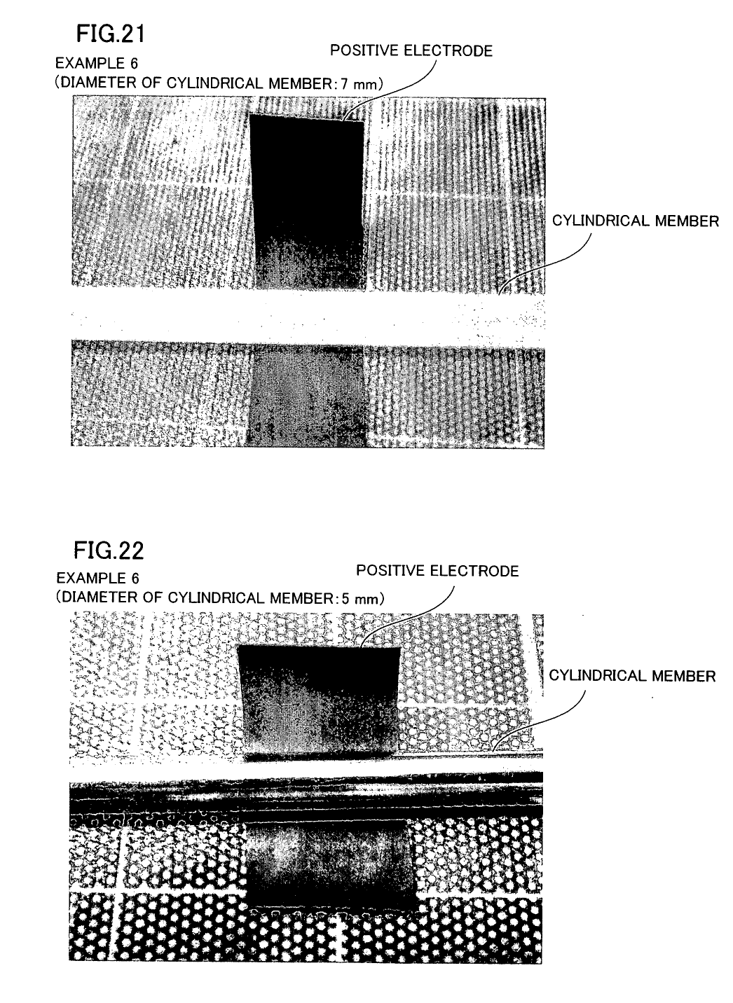

The flexibility experiments were performed as to the positive electrodes of the lithium secondary batteries according to Examples 6 and 7 prepared in the aforementioned manner. As specific experimental conditions, situations of cracking of the positive electrodes at the time of bending the positive electrodes according to Examples 6 and 7 along the outer edges of the respective ones of a plurality of types of cylindrical members having different diameters were checked on the assumption that cylindrical lithium secondary batteries are formed. The diameters of the cylindrical members employed for the flexibility experiments were five types including 2 mm, 3 mm, 5 mm, 7 mm and 10 mm. In Example 6, no flexibility experiment with the cylindrical member having the diameter of 10 mm was performed. In Example 7, no flexibility experiment with the cylindrical member having the diameter of 2 mm was performed. The following Table 1 shows the results, and FIGS. 21 to 28 shows the states of the positive electrodes according to Examples 6 and 7 wound on the respective cylindrical members. “◯” in Table 1 shows that no cracking took place in the positive electrodes, and “X” shows that cracking took place in the positive electrodes.

TABLE 1

| | Radius of | Radius of Curvature | | |
|---|---|---|---|---|
| | Curvature | with Respect to | | |
| Diameter of | of | Thickness (125 μm) | | |
| Cylindrical | Positive | of Positive | | |
| Member | Electrode | Electrode Active | | |
| (mm) | (mm) | Material Layer | Example 6 | Example 7 |
| 2 | 1 | 8 times | X | — |
| 3 | 1.5 | 12 times | ◯ | X |
| 5 | 2.5 | 20 times | ◯ | X |
| 7 | 3.5 | 28 times | ◯ | X |
| 10 | 5 | 40 times | — | ◯ |

Referring to the above Table 1, it has been proved that the lower limit (1.5 mm) of the radius of curvature of the positive electrode capable of suppressing cracking of the positive electrode according to Example 6 employing polyvinylidene fluoride as the binder is smaller than the lower limit (5 mm) of the radius of curvature of the positive electrode capable of suppressing cracking of the positive electrode according to Example 7 employing polyacrylonitrile as the binder in the case of employing tungsten as the conducting materials of the positive electrode active material layers.

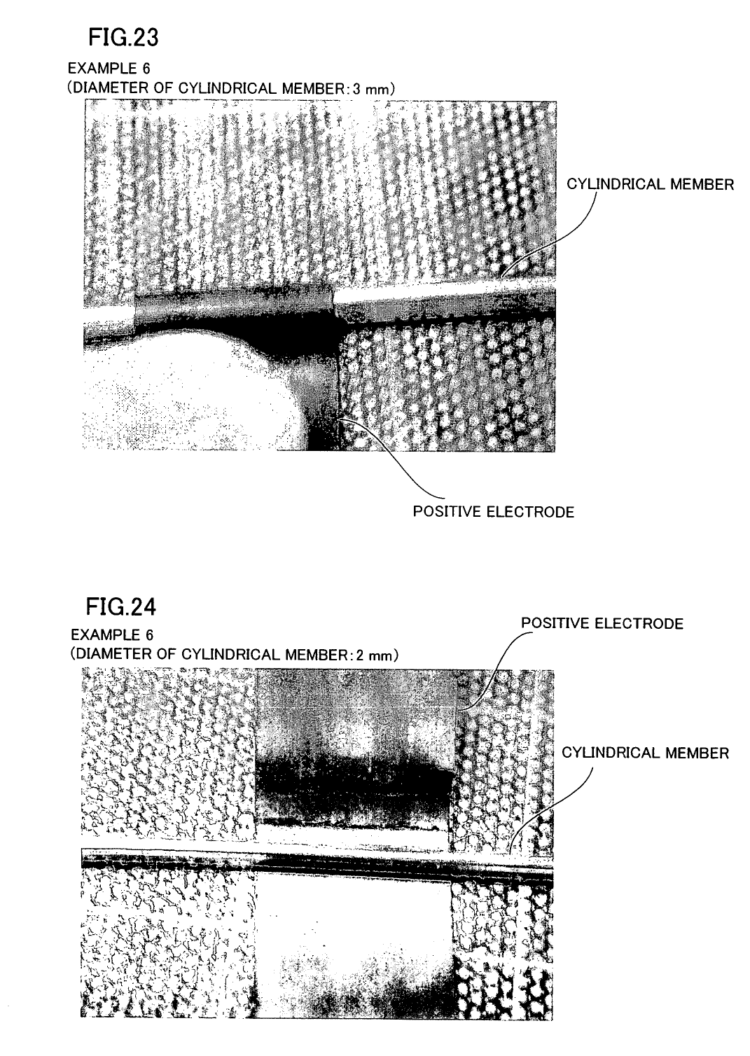

More specifically, it was possible to inhibit the positive electrode from cracking when winding the positive electrode on the cylindrical member having the diameter of 7 mm (radius of curvature of the positive electrode: 3.5 mm (28 times the thickness of the positive electrode active material layer)) in Example 6, as shown in Table 1 and FIG. 21. Also when winding the positive electrode on the cylindrical member having the diameter of 5 mm (radius of curvature of the positive electrode: 2.5 mm (20 times the thickness of the positive electrode active material layer)) in Example 6, it was possible to inhibit the positive electrode from cracking, as shown in Table 1 and FIG. 22. Also when winding the positive electrode on the cylindrical member having the thickness of 3 mm (radius of curvature of the positive electrode: 1.5 mm (12 times the thickness of the positive electrode active material layer)) in Example 6, it was possible to inhibit the positive electrode from cracking, as shown in Table 1 and FIG. 23. When winding the positive electrode on the cylindrical member having the diameter of 2 mm (radius of curvature of the positive electrode: 1 mm (8 times the thickness of the positive electrode active material layer)) in Example 6, on the other hand, cracking took place in the positive electrode (positive electrode active material layer), as shown in Table 1 and FIG. 24. In other words, it has been proved possible to inhibit the positive electrode from cracking in Example 6 employing tungsten carbide and polyvinylidene fluoride as the conducting material and the binder respectively when the radius of curvature of the positive electrode is at least 1.5 mm.

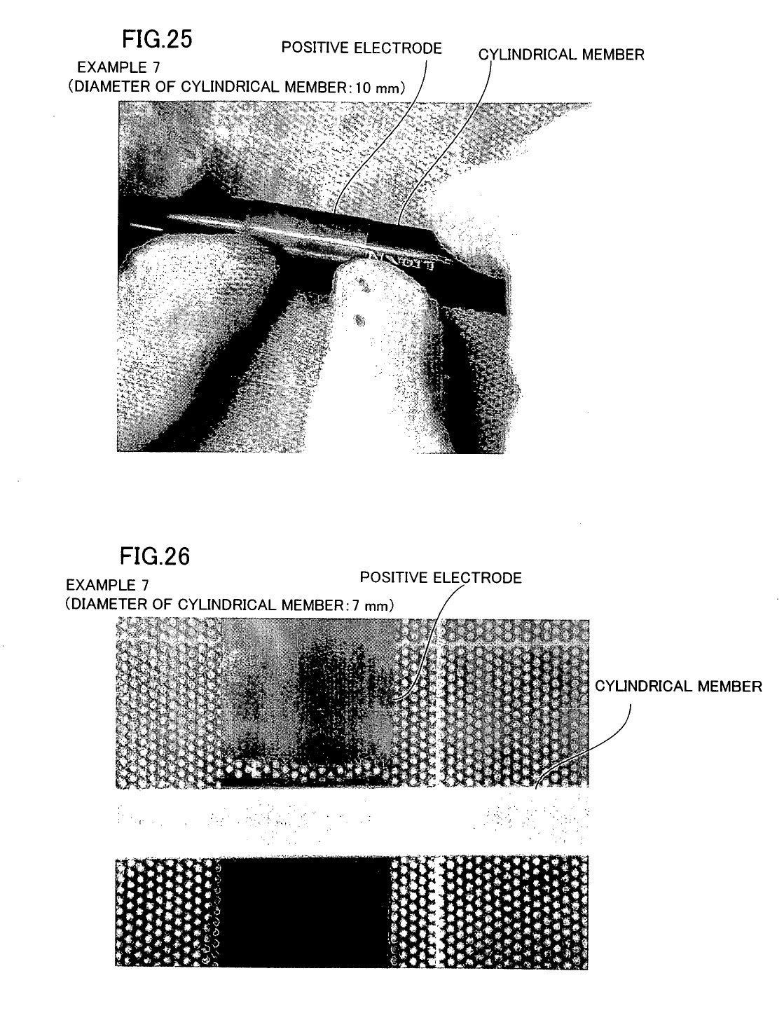

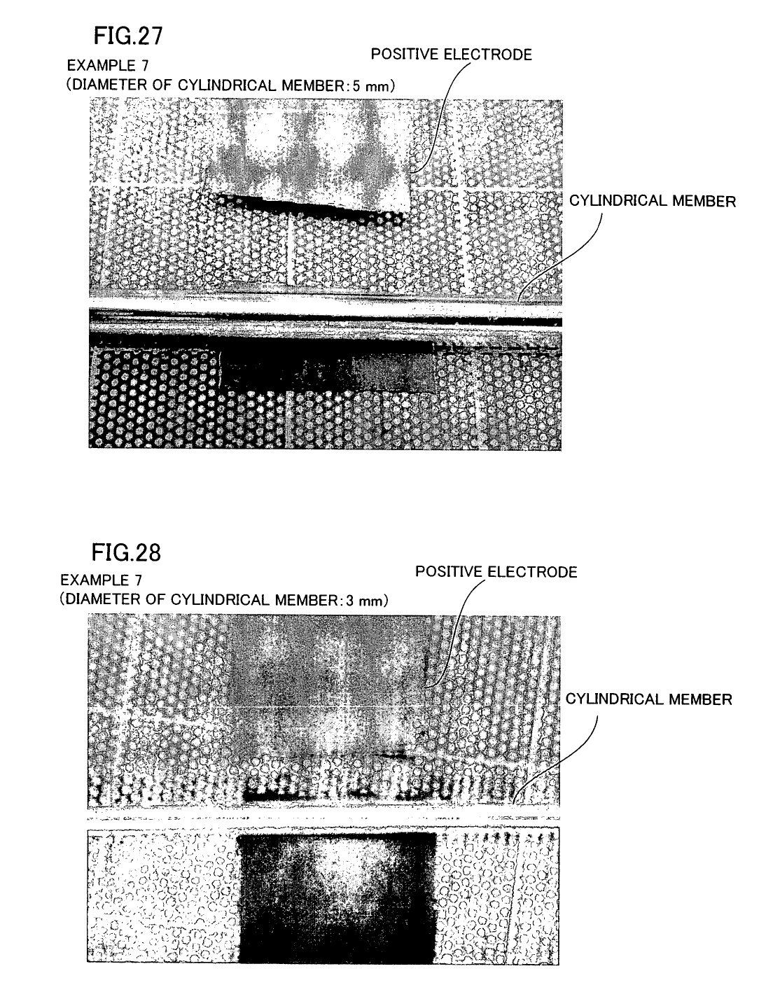

When winding the positive electrode on the cylindrical member having the diameter of 10 mm (radius of curvature of the positive electrode: 5 mm (40 times the thickness of the positive electrode active material layer)) in Example 7, it was possible to inhibit the positive electrode from cracking, as shown in Table 1 and FIG. 25. When winding the positive electrode on the cylindrical member having the diameter of 7 mm (radius of curvature of the positive electrode: 3.5 mm (28 times the thickness of the positive electrode active material layer)) in Example 7, on the other hand, cracking took place in the positive electrode, as shown in Table 1 and FIG. 26. Also when winding the positive electrode on the cylindrical member having the thickness of 5 mm (radius of curvature of the positive electrode: 2.5 mm (20 times the thickness of the positive electrode active material layer)) in Example 7, cracking took place in the positive electrode, as shown in Table 1 and FIG. 27. Also when winding the positive electrode on the cylindrical member having the thickness of 3 mm (radius of curvature of the positive electrode: 1.5 mm (12 times the thickness of the positive electrode active material layer)) in Example 7, cracking took place in the positive electrode, as shown in Table 1 and FIG. 28. In other words, it has been proved that the radius of curvature of the positive electrode must be at least 5 mm in the positive electrode according to Example 7 employing tungsten carbide and polyacrylonitrile as the conducting material and the binder respectively, in order to inhibit the positive electrode from cracking.

From these results, it is conceivable that the flexibility of the positive electrode including the positive electrode active material layer improves due to the employment of polyvinylidene fluoride as the binder in the case of employing tungsten as the conducting material of the positive electrode active material layer, as compared with the case of employing polyacrylonitrile as the binder.

According to Example 6, as hereinabove described, it is possible to improve the flexibility of the positive electrode active material layer employing tungsten carbide as the conducting material by employing polyvinylidene fluoride as the binder of the positive electrode active material layer, since polyvinylidene fluoride has relatively high flexibility among materials employed as binders. Thus, the flexibility of the positive electrode including the positive electrode active material layer employing tungsten carbide as the binder can be improved, whereby it is possible to inhibit the positive electrode from cracking when bending the positive electrode in a case of preparing a cylindrical lithium secondary battery (nonaqueous electrolyte battery).

According to Examples 6 and 7, it is possible to increase the capacities of the lithium secondary batteries (nonaqueous electrolyte batteries) while suppressing reduction of conductivity of the positive electrode active material layers and reduction of the capacities resulting from chemical reaction of the conducting materials similarly to the aforementioned Examples 2 and 3, by employing tungsten carbide as the conducting materials and setting the average particle diameters of the particles of tungsten carbide to at least 0.2 μm and not more than 5 μm (0.98 μm).

The remaining effects of Examples 6 and 7 are similar to those of the aforementioned Examples 2 and 3.

Examples disclosed this time must be considered as illustrative in all points and not restrictive. The scope of the present invention is shown not by the above description of Examples but by the scope of claim for patent, and all modifications within the meaning and range equivalent to the scope of claim for patent are included.

For example, while the examples of applying the present invention to lithium secondary batteries have been described in the above Examples 1 to 7, the present invention is not restricted to this but is also applicable to a nonaqueous electrolyte battery other than the lithium secondary battery.

While zirconium nitride as the metal nitride and tungsten carbide, tantalum carbide and zirconium as the metal carbides were employed in the aforementioned Examples 1 to 7, the present invention is not restricted to this but similar effects can be attained also when employing at least one non-carbon material selected from a group consisting of nitrides, carbides and borides. As a metal nitride other than zirconium nitride, at least one material selected from a group consisting of NbN, TiN, Ti₃N₄, VN, Cr₂N, Fe₂N, Cu₃N, GaN, Mo₂N, Ru₂N, TaN, Ta₂N, HfN, ThN₂, Mo₂N, Mn₃N₂, CO₃N₂, Ni₃N₂, W₂N and Os₂N can be listed, for example. Among the aforementioned metal nitrides, TiN, Ti₃N₄, TaN and Ta₂N have specific resistances approximate to the non-resistance (40×10⁻⁶ Ωcm to 70×10⁻⁶ Ωcm) of carbon, whereby it is possible to ensure more excellent conductivity when employing TiN, Ti₃N₄, TaN or Ta₂N as the conducting material. The specific resistances of TiN and Ti₃N₄ are 2.17×10⁻⁵ Ωcm, and the specific resistances of TaN and Ta₂N are 2×10⁻⁴ Ωcm. As metal carbides other than tungsten carbide, tantalum carbide and zirconium carbide, HfC, B₄C, MoC, NbC and TiC can be listed, for example.

While zirconium nitride (1.36×10⁻⁵ Ωcm), tungsten carbide (8×10⁻⁵ Ωcm), tantalum carbide (3×10⁻⁵ Ωcm) and zirconium carbide (7×10⁻⁵ Ωcm) having specific resistances approximate to the specific resistance (4×10⁻⁵ Ωcm to 7×10⁻⁵ Ωcm) of carbon were employed as the conducting materials in the aforementioned Examples 1 to 7, the present invention is not restricted to this but a material inferior in conductivity as compared with carbon may be employed as the conducting material if it is possible to increase the filling density of the positive electrode active material layer.

While layered rock salt lithium cobaltate was employed as the positive electrode active materials in the aforementioned Examples 1 to 7, the present invention is not restricted to this but a material other than layered rock salt lithium cobaltate may be employed as the positive electrode active material if the same is a layered rock salt material containing at least either cobalt or nickel. As the layered rock salt material containing at least either cobalt or nickel, a lithium-cobalt composite oxide having a composition formula expressed as LiCOₐM₁₋ₐO₂ (0<a≦1) can be listed, for example. M in the composition formula of LiCOₐM₁₋ₐO₂ is at least one selected from a group consisting of B, Mg, Al, Ti, Mn, V, Fe, Ni, Cu, Zn, Ga, Y, Zr, Nb, Mo and In. A lithium-nickel composite oxide having a composition formula expressed as LiNi_{b}M_{1-b}O₂ (0<b≦1) can also be listed. M in the composition formula of LiNi_{b}M_{1-b}O₂ is at least one selected from a group consisting of B, Mg, Al, Ti, Mn, V, Fe, Co, Cu, Zn, Ga, Y, Zr, Nb, Mo and In.

While the nonaqueous electrolytes containing the mixed solvents of ethylene carbonate and diethyl carbonate were employed in the aforementioned Examples 1 to 5, the present invention is not restricted to this but a solvent other than the mixed solvent of ethylene carbonate and diethyl carbonate may be employed if the same is usable as the solvent of the nonaqueous electrolyte battery. As solvents other than the mixed solvent of ethylene carbonate and diethyl carbonate, cyclic carbonic acid ester, chain carbonic acid ester, esters, cyclic ethers, chain ethers, nitrites and amides can be listed, for example. As cyclic carbonic acid ester, propylene carbonate and butylene carbonate can be listed, for example. Further, cyclic carbonic acid ester whose hydrogen groups are partially or entirely fluorinated is also usable, and trifluoropropylene carbonate and fluoroethyl carbonate can be listed, for example. As chain carbonic acid ester, dimethyl carbonate, ethyl methyl carbonate, methyl propyl carbonate, ethyl propyl carbonate and methyl isopropyl carbonate can be listed, for example. Chain carbonic acid ester whose hydrogen groups are partially or entirely fluorinated is also usable.

As esters, methyl acetate, ethyl acetate, propyl acetate, methyl propionate, ethyl propionate and γ-butyrolactone can be listed, for example. As cyclic ethers, 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol and crown ether can be listed. As chain ethers, 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, bentyl phenyl ether, methoxytoluene, benzyl ethyl ether, diphenyl ether, dibenzyl ether, O-dimethoxy benzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether and tetraethylene glycol dimethyl can be listed, for example. As nitriles, acetonitrile can be listed, for example. As amides, dimethylformamide can be listed, for example.

While the nonaqueous electrolytes in which lithium hexafluorophosphate as the solute was dissolved were employed in the aforementioned Examples 1 to 5, the present invention is not restricted to this but a nonaqueous electrolyte in which a solute other than lithium hexafluorophosphate is dissolved may be employed. As solutes other than lithium hexafluorophosphate, lithium difluoro(oxalate)borate (substance expressed in the following chemical formula Chem 1), LiAsF₆, LiBF₄, LiCF₃SO₃, LiN(CₗF₂ₗ₊₁SO₂)(CₘF₂ₘ₊₁SO₂) and LiC(CₚF₂ₚ₊₁SO₂)(C_{q}F_{2q+1}SO₂)(CᵣF₂₊ᵣSO₂) can be listed, for example. l, m, p, q and r in the above composition formulas are integers of at least 1. Further, a mixture obtained by combining at least two materials selected from the group consisting of the aforementioned solutes may be employed as the solute. The aforementioned solvent is preferably dissolved in the solvent with a concentration of 0.1 M to 1.5 M. Further, the aforementioned solvent is more preferably dissolved in the solvent with a concentration of 0.5 M to 1.5 M.

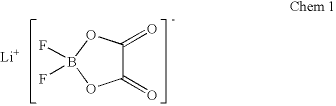

While polyvinylidene fluoride was employed as the binder of the positive electrode active material layer in the aforementioned Example 6, the present invention is not restricted to this but polymer fluoride other than polyvinylidene fluoride may be employed as the binder of the positive electrode active material layer. As polymer fluoride other than polyvinylidene fluoride, polytetrafluoroethylene and fluoroethylene propylene can be listed. Further, at least two materials from among polyvinylidene fluoride, polytetrafluoroethylene and fluoroethylene propylene may be employed as binders of the positive electrode active material layer.

While the positive electrode mixture slurries as the positive electrode active material layers were applied to both of the front and back surfaces of the collectors in the aforementioned Examples 6 and 7, the present invention is not restricted to this but the positive electrode mixture slurry as the positive electrode active material layer may be applied to only one surface of the collector.

While the above Examples 6 and 7 have been described on the assumption that cylindrical lithium secondary batteries are formed, the present invention is not restricted to this but is similarly applicable also as to an angular lithium secondary battery, and it is possible to obtain flexibility similar to that in the cylindrical case by employing polymer fluoride such as polyvinylidene fluoride as a binder of a positive electrode active material layer.

1. A nonaqueous electrolyte battery comprising:
a positive electrode (1) including a positive electrode active material layer;
a negative electrode (2) including a negative electrode active material layer;
a nonaqueous electrolyte (5) substantially constituted of only a solvent and a solute; and
a conducting material, contained in said positive electrode active material layer and constituted of at least one non-carbon material selected from a group consisting of nitrides, carbides and borides, having particles of at least 0.2 μm and not more than 5 μm in average diameter easily dispersed into said positive electrode active material layer, wherein
a positive electrode active material constituting said positive electrode active material layer has a layered rock salt structure, and
the filling density of said positive electrode active material layer is at least 4.0 g/ml.

2. (canceled)

3. The nonaqueous electrolyte battery according to claim 1, wherein said positive electrode active material having a layered rock salt structure is constituted of a material containing at least either cobalt or nickel.

4. The nonaqueous electrolyte battery according to claim 1 or 3, wherein said conducting material includes a metal nitride.

5. The nonaqueous electrolyte battery according to claim 4, wherein said metal nitride includes zirconium nitride (ZrN or Zr₃N₂).

6. The nonaqueous electrolyte battery according to claim 5, wherein said zirconium nitride constituting said conducting material is contained in said positive electrode active material layer with a content of at least 1 mass % and not more than 20 mass %.

7. The nonaqueous electrolyte battery according to claim 1 or 3, wherein said conducting material includes a metal carbide.

8. The nonaqueous electrolyte battery according to claim 7, wherein said metal carbide includes tungsten carbide.

9. The nonaqueous electrolyte battery according to claim 7, wherein said metal carbide includes tantalum carbide.

10. The nonaqueous electrolyte battery according to claim 7, wherein said metal carbide includes zirconium carbide.

11. The nonaqueous electrolyte battery according to claim 1, further comprising a binder, contained in said positive electrode active material layer, including polymer fluoride.

12. The nonaqueous electrolyte battery according to claim 11, wherein said polymer fluoride includes polyvinylidene fluoride.

13. The nonaqueous electrolyte battery according to claim 11 or 12, wherein said positive electrode is cylindrically or angularly formed.

14. (canceled)

15. (canceled)

16. (canceled)

17. (canceled)
